(19) United States
(12) Patent Application Publication
(10) Pub. No.: US 2006/0044236 A1
(43) Pub. Date: Mar. 2, 2006

(54) Light emitting display and driving method including demultiplexer circuit

(76) Inventor: Yang Wan Kim, Seoul (KR)

Correspondence Address: CHRISTIE, PARKER & HALE, LLP, PO BOX 7068, PASADENA, CA, 91109-7068, US

(21) Appl. No.: 11/197,173

(22) Filed: Aug. 3, 2005

(30) Foreign Application Priority Data
Aug. 25, 2004 (KR) 2004-67282

(51) Int. Cl. G09G 3/32

(52) U.S. Cl. 345/82

(57) ABSTRACT

A light emitting display and its driving method using a demultiplexer to reduce the number of output lines of a data driver. The light emitting display includes a scan driver supplying a scan signal to a scan line, a data driver having output lines and supplying data signals to the output lines, a demultiplexer in each output line and supplying the data signal from each one output line to a number of data lines, an image displaying part including pixels formed in regions defined by the scan and data lines, and a capacitor coupled to each data line to be charged with a voltage corresponding to the data signal supplied to the data line. With this configuration, the number of output lines required in the data driver is reduced. Further, the voltages charged in the data capacitors are supplied to the pixels simultaneously, thereby displaying an image with uniform brightness.

### CROSS-REFERENCE TO RELATED APPLICATION

This application claims priority to and the benefit of Korean Patent Application No. 2004-67282, filed on Aug. 25, 2004, in the Korean Intellectual Property Office, the entire content of which is incorporated herein by reference.

### BACKGROUND

1. Field of the Invention

The present invention relates to a light emitting display and a driving method thereof, and more particularly, to a light emitting display and a driving method thereof, in which the number of output lines provided in a data driver is reduced by using a demultiplexer.

2. Discussion of Related Art

Recently, various flat panel displays have been developed, which are more desirable substitutes for a cathode ray tube (CRT) display because the CRT display is relatively heavy and bulky. The flat panel displays include liquid crystal displays (LCD), field emission displays (FED), plasma display panels (PDP), light emitting displays (LED), and the like.

Among the flat panel displays, the LED can emit light by electron-hole recombination. Such a LED has advantages in that response time is relatively fast and power consumption is relatively low. Typically, the LED employs a thin film transistor (TFT) in supplying current corresponding to a data signal to a light emitting device provided in each pixel.

FIG. 1 is a plan view of a conventional LED which includes an image displaying part 30 having a plurality of pixels 40 formed in a region adjacent to where a plurality of scan lines S1 through Sn and a plurality of data lines D1 through Dm cross one another. A scan driver 10 drives the scan lines S1 through Sn. A data driver 20 drives the data driver D1 through Dm. A timing controller 50 controls the scan driver 10 and the data driver 20.

The scan driver 10 generates scan signals in response to scan control signals SCS transmitted from the timing controller 50, and supplies the scan signals to the scan lines S1 through Sn in sequence. Further, the scan driver 10 generates emission control signals in response to the scan control signals SCS, and supplies the emission control signals to emission control lines E1 through En in sequence.

The data driver 20 generates data signals in response to data control signals DCS transmitted from the timing controller 50, and supplies the data signals to the data lines D1 through Dm. The data driver 20 supplies the data signal corresponding to one horizontal line per horizontal period to the data lines D1 through Dm.

The timing controller 50 generates the data control signals DCS and the scan control signals SCS in response to external synchronization signals. The data control signal DCS is transmitted to the data driver 20, and the scan control signal SCS is transmitted to the scan driver 10. Further, the timing controller 50 rearranges external data Data and supplies it to the data driver 20.

The image displaying part 30 receives external first voltage VDD and external second voltage VSS. The first voltage VDD and the second voltage VSS are supplied to the pixels 40. Each pixel 40 receives the data signal and displays an image corresponding to the data signal. Further, an emission time of the pixels 40 is controlled corresponding to the emission control signal.

In the conventional LED, the pixels 40 are placed in the regions where the scan lines S1 through Sn and the data lines D1 through Dm cross one another. The data driver 20 includes m output lines to supply the data signals to m data lines D1 through Dm. That is, the data driver 20 of the conventional LED has the same number of output lines as the number of the data lines D1 through Dm. Therefore, the data driver 20 includes a plurality of data integrated circuits so as to have m output lines, resulting in a problem of increased production cost. Particularly, as the resolution and the size of the image displaying part 30 increase, the number of output lines of the data driver 20 increases, thus increasing the production cost of the LED.

### SUMMARY OF THE INVENTION

In accordance with the present invention a LED and a driving method for the LED are provided, where the number of output lines in the data driver is reduced.

The foregoing and/or other aspects of the present invention are achieved by providing a LED including a scan driver supplying a scan signal to a scan line during a first period in one horizontal period, a data driver provided with a plurality of output lines and supplying a plurality of data signals to the respective output lines during a second period in the one horizontal period not coinciding from the first period, a demultiplexer provided in each output line and supplying the data signal from the output line to a plurality of data lines, an image displaying part including a plurality of pixels formed in regions defined by the scan lines and the data lines, and a capacitor coupled to each data line to be charged with a voltage corresponding to the data signal supplied to the data line. Each pixel includes a light emitting device capable of producing emitted light upon receiving one of the data signals.

According to an aspect of the invention, each pixel includes a plurality of transistors, and at least one of the transistors is connected to function as a diode. Further, an initialization voltage is supplied to the transistor functioning as the diode to apply a forward biased voltage thereto when the data signal is transmitted to the pixels. Each demultiplexer may include a plurality of transistors coupled to the respective data lines. The LED further includes a demultiplexer controller to supply a control signal to the plurality of transistors to be turned on in sequence during the second period.

Other aspects of the present invention include a method of driving a LED, including supplying a scan signal to a scan line during a first period in one horizontal period, supplying a plurality of data signals to the respective output lines of a data driver during a second period in the one horizontal period aside from the first period, turning on a plurality of transistors coupled to the respective output lines in sequence during the second period to supply the data signal to a plurality of data lines, and charging a capacitor coupled to each data line with voltage corresponding to the data signal.

According to another aspect of the invention, the voltage charged in the capacitor during the second period is supplied to pixels coupled to the scan line and the data line during a first period of a subsequent horizontal period. Further, the method includes supplying a dummy data signal having no effect on brightness to each output line provided in the data driver during the first period. Also, the dummy data signal supplied during the first period in a k^{th} horizontal period is set as the last data signal supplied during the second period in a (k−1)^{th} horizontal period, where k is a natural number.

Still other aspects of the present invention are achieved by providing a method of driving a LED including charging capacitors coupled to data lines in sequence with voltages corresponding to data signals, and supplying the voltages charged in the capacitors to the pixels at the same time.

According to another aspect of the invention, the capacitor is charged with the voltage corresponding to the data signal during the first period in the one horizontal period. Further, each pixel receives the voltage charged in the capacitor during the second period in the one horizontal period.

As described above, the present invention provides a LED and a driving method for the LED, in which a data signal supplied from one output line can be split and supplied to a plurality of second data lines, thereby decreasing the number of output lines and reducing the production cost. Further, the present invention provides a LED and a driving method for the LED, in which voltages corresponding to the data signals are charged in data capacitors in sequence, and the charged voltages are supplied to the pixels at the same time, thereby displaying an image with uniform brightness. Still further, the present invention provides a LED and a driving method for the LED, in which a scan period for supplying a scan signal and a data period for supplying a data signal do not overlap, thereby displaying an image in a stable manner.

### BRIEF DESCRIPTION OF THE DRAWINGS

FIG. 1 is a plan view of a conventional LED.

FIG. 2 is a plan view of a LED according to an embodiment of the present invention.

FIG. 3 is a circuit diagram of a demultiplexer provided in the LED according to an embodiment of the present invention.

FIGS. 4A and 4B illustrate waveforms of signals applied to a scan line, to a data line, and to the demultiplexer according to an embodiment of the present invention.

FIG. 5 is a circuit diagram of a pixel provided in the LED according to a first embodiment of the present invention.

FIG. 6 is a circuit diagram showing connection between the demultiplexer and the pixel according to the first embodiment of the present invention.

FIG. 7 is a circuit diagram of a pixel provided in the LED according to a second embodiment of the present invention.

FIG. 8 is a circuit diagram showing connection between the demultiplexer and the pixel according to the second embodiment of the present invention.

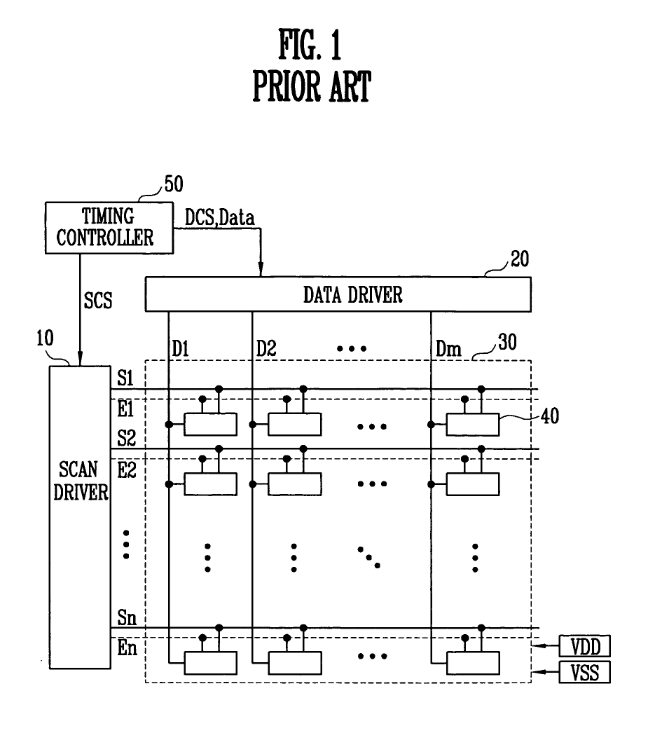

### DETAILED DESCRIPTION

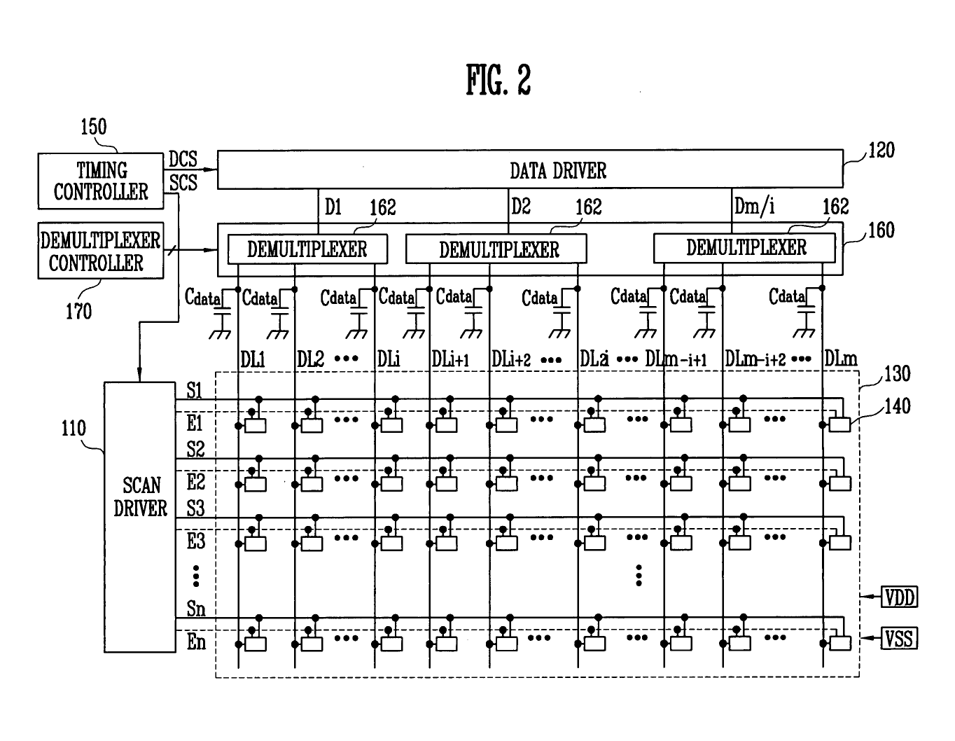

Referring now to FIG. 2, an LED includes a scan driver 110, a data driver 120, an image displaying part 130, a timing controller 150, a demultiplexing block 160, a demultiplexer controller 170, and a data capacitor Cdata.

The image displaying part 130 includes a plurality of pixels 140 placed adjacent to regions defined by a plurality of scan lines S1 through Sn and a plurality of second data lines DL, including second data lines DL1 through DLm. Each pixel 140 emits light corresponding to a data signal transmitted through the second data line DL.

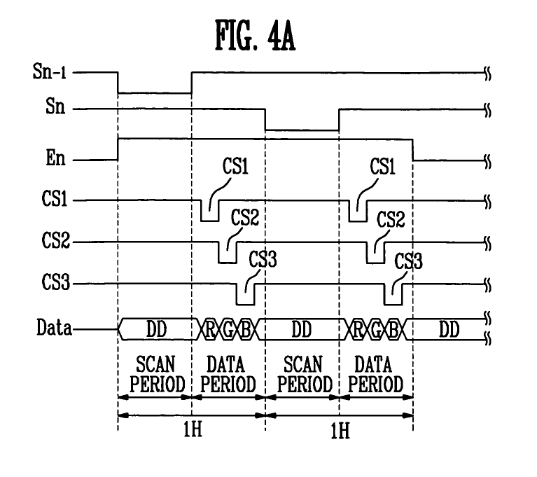

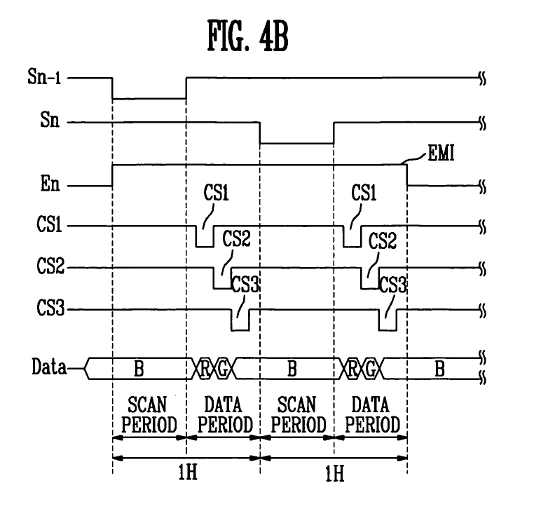

The scan driver 110 generates a scan signal in response to a scan control signal SCS supplied from the timing controller 150, and supplies the scan signals to the scan lines S1 through Sn in sequence. The scan driver 110 supplies the scan signal during a predetermined period in one horizontal period 1H (shown in FIG. 4A).

The one horizontal period 1H according to an embodiment of the present invention is divided into a scan period (first period) and a data period (second period). That is, the scan driver 110 supplies the scan signal to the scan lines during the scan period of the one horizontal period 1H. On the other hand, the scan driver 110 does not supply the scan signal during the data period of the one horizontal period 1H. Further, the scan driver 110 generates the emission control signals in response to the scan control signals SCS, and supplies the emission control signals to emission control lines E1 through En in sequence.

The data driver 120 generates the data signal in response to a data control signal DCS supplied from the timing controller 150, and supplies the data signals to a plurality of first data lines D, including data lines D1 through Dm/i. The data driver 120 supplies i or i+1 data signals (where i is a natural number equal to 2 or more) in sequence to the first data lines D1 through Dm/i coupled to output lines of the data driver 120.

For example, the data driver 120 supplies real data signals R, G, B to the pixel in sequence during the data period in the one horizontal period 1H. The real data signals red (R), green (G), blue (B) are supplied during only the data period, so that the real data signals R, G, B are not overlapped with the scan signal. Further, the data driver 120 supplies a dummy data signal DD during the scan period of the one horizontal period 1H. The dummy data signal DD can be set as various data signals, which are not displayed as an image. For instance, the dummy data signal DD can be set as the last data signal B of the previous data period (refer to FIG. 4B). That is, the dummy data signal supplied during the scan period of the k^{th} horizontal period can be selected as the last data signal supplied during the data period of the (k−1)^{th} horizontal period. In the case where the dummy data signal DD supplied during the current data period is selected as the last data signal B supplied during the previous data period, the number of switching times for the data driver 120 is decreased, thereby reducing power consumption.

The timing controller 150 generates the data control signals DCS and the scan control signals SCS corresponding to external synchronization signals. The data control signals DCS generated in the timing controller 150 are supplied to the data driver 120, and the scan control signals SCS generated in the timing controller 150 are supplied to the scan driver 110.

The demultiplexer block 160 includes m/i demultiplexers 162. In other words, the demultiplexer block 160 has the same number of demultiplexers 162 as the number of first data lines D, and the demultiplexers 162 are coupled to the first data lines D1 through Dm/i, respectively. Further, the demultiplexers 162 are coupled to i second data lines DL. Thus, the demultiplexer 162 processes idata signals during the data period, and supplies them to i second data lines DL.

As the data signal received through one of the first data lines D is supplied to i second data lines DL, the number of output lines required in the data driver 120 is decreased. For instance, when i is 3, the number of output lines required in the data driver 120 is decreased by ⅓, and thus the number of data integrated circuits required in the data driver 120 is decreased. That is, according to an embodiment of the present invention, the demultiplexer 162 is employed for supplying the data signal of one first data line D to i second data lines DL, thereby reducing production cost of the LED.

The demultiplexer controller 170 supplies i control signals to the respective demultiplexers 162 during the data period in the one horizontal period, thereby splitting the data signal into i data signals and supplying i data signals from the first data line D to i second data lines DL. The demultiplexer controller 170 supplies i control signals in sequence, so that i control signals are not overlapped as shown in FIG. 4A. In this embodiment of the demultiplexer controller 170 is separately provided outside the timing controller 150, but not limited to and may be integrally provided inside the timing controller 150.

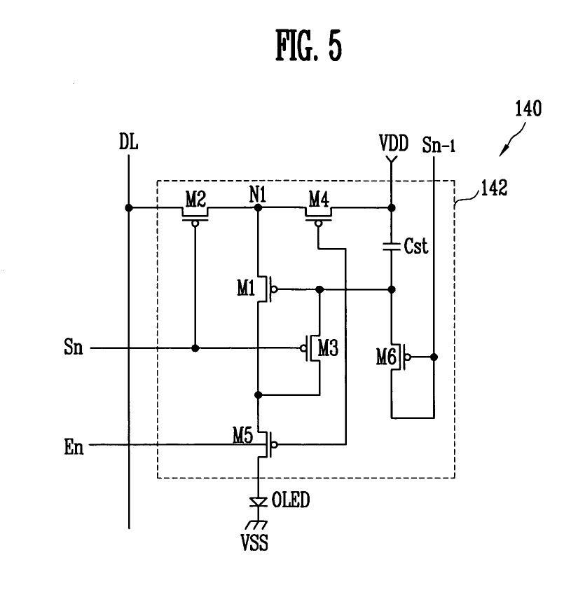

The data capacitor Cdata is provided in every second data line DL. The data capacitor Cdata temporarily stores the data signal supplied to the second data line DL, and later supplies the stored data signal to the pixel 140. The data capacitor Cdata may be a parasitic capacitor equivalently formed by the second data line DL. Further, an external capacitor Cst (shown on FIG. 5) can be additionally provided on every second data line DL. According to one embodiment of the present invention, the capacitance of the data capacitor Cdata is larger than the storage capacitor Cst provided in every pixel 140.

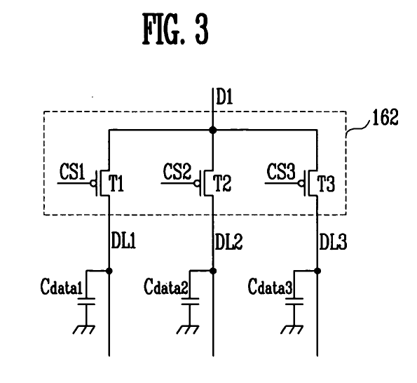

FIG. 3 is a circuit diagram of a demultiplexer 162 provided in the LED according to an embodiment of the present invention. An exemplary demultiplexer 162 includes a first switching device (or transistor) T1, a second switching device T2, and a third switching device T3. For the sake of convenience, i is set to be equal to 3. So, there are three switching devices T1, T2, T3 coupling to three second data lines DL1, DL2, DL3. Also as a convenient example, the demultiplexer 162 is shown as coupled to the 1^{st} first data line D1.

The first switching device T1 is coupled between the 1^{st} first data line D1 and the 1^{st} second data line DL1. The first switching device T1 is turned on after receiving a first control signal CS1 from the demultiplexer controller 170, and supplies the data signal from the 1^{st} first data line D1 to the 1^{st} second data line DL1. The data signal supplied to the 1^{st} second data line DL1 is temporarily stored in the first data capacitor Cdata1.

The second switching device T2 is coupled to the 1^{st} first data line D1 and the 2^{nd} second data line DL2. The second switching device T2 is turned on when it receives a second control signal CS2 from the demultiplexer controller 170, and supplies the data signal from the 1^{st} first data line D1 to the 2^{nd} second data line DL2. The data signal supplied to the 2^{nd} second data line DL2 is temporarily stored in the second data capacitor Cdata2.

The third switching device T3 is coupled to the 1^{st} first data line D1 and the 3^{rd} second data line DL2. The third switching device T3 is turned on when it receives a third control signal CS3 from the demultiplexer controller 170, and supplies the data signal from the 1^{st} first data line D1 to the 3^{rd} second data line DL3. The data signal supplied to the 3^{rd} second data line DL3 is temporarily stored in the third data capacitor Cdata3. With this exemplary configuration, operations of the demultiplexer 162 will be described in association with configurations of the pixel 140.

FIG. 5 is a circuit diagram of a pixel 140 provided in the LED according to a first embodiment of the present invention. The pixel 140 is not limited to the structure shown in FIG. 5, and may include at least one transistor capable of being used as a diode. Each pixel 140 according to the first embodiment of the present invention includes a light emitting device OLED and a pixel circuit 142 coupled to the second data line DL, to the scan line Sn, and to the emission control line En. The pixel circuit 142 controls and causes the light emitting device OLED to emit light.

The light emitting device OLED includes an anode electrode coupled to the pixel circuit 142, and a cathode electrode coupled to a second power line of a second voltage VSS. The second power line is applied with the second voltage VSS that is lower than that of a first power line that is applied a first voltage VDD. For example, ground voltage can be applied as the second voltage VSS to the second power line. The light emitting device OLED emits light corresponding to current supplied from the pixel circuit 142. For this, the light emitting device OLED may include fluorescent and/or phosphorescent organic material.

The pixel circuit 142 includes the storage capacitor Cst and a sixth transistor M6 which are coupled between the first voltage VDD and an (n−1)^{th} scan line Sn−1, a second transistor M2 and a fourth transistor M4 which are coupled between the first voltage VDD and the data line DL, a fifth transistor M5 which is coupled between the light emitting device OLED and the emission control line En, a first transistor M1 which is coupled between the fifth transistor M5 and a first node N1 to which the second electrode M2 and the fourth transistor M4 are commonly coupled, and a third transistor M3 coupled between a gate terminal and a drain terminal of the first transistor M1. While in FIG. 5, the first through sixth transistors M1, M2, M3, M4, M5, M6 are shown as p-type metal oxide semiconductor field effect transistors (PMOSFET), these transistors may be of a different type. Alternatively, the first through sixth transistors M1, M2, M3, M4, M5, M6 may be of an n-type metal oxide semiconductor field effect transistor (NMOSFET). In the case where the first through sixth transistors M1, M2, M3, M4, M5, M6 are of the NMOSFET type, polarity of driving waveforms is reversed as well-known to those skilled in the art.

The first transistor M1 includes a source terminal coupled to the first node N1, the drain terminal coupled to a source terminal of the fifth transistor M5, and the gate terminal coupled to the storage capacitor Cst. Further, the first transistor M1 supplies current corresponding to voltage charged in the storage capacitor Cst to the light emitting device OLED.

The third transistor M3 includes a drain terminal coupled to the gate terminal of the first transistor M1, a source terminal coupled to the drain terminal of the first transistor M1, and a gate terminal coupled to the n^{th} scan line Sn. As such, the third transistor M3 is turned on when the scan signal is transmitted to the n^{th} scan line Sn, and thus makes the first transistor M1 function as a diode. That is, when the third transistor M3 is turned on, the first transistor M1 functions as a diode.

The second transistor M2 includes a source terminal coupled to the data line DL, a drain terminal coupled to the first node N1, and a gate terminal coupled to the n^{th} scan line Sn. Therefore, the second transistor M2 is turned on when the scan signal is transmitted to the n^{th} scan line Sn, thereby transmitting the data signal from the data line DL to the first node N1.

The fourth transistor M4 includes a drain terminal coupled to the first node N1, a source terminal coupled to the first power line VDD, and a gate terminal coupled to the emission control line En. Further, the fourth transistor M4 is turned on when an emission control signal EMI is not supplied to the n^{th} emission control line En, thereby electrically coupling the first voltage VDD with the first node N1.

The fifth transistor M5 includes the source terminal coupled to the drain terminal of the first transistor M1, a drain terminal coupled to the light emitting device OLED, and a gate terminal coupled to the emission control line En. Further, the fifth transistor M5 is turned on when the emission control signal EMI is not supplied, thereby supplying current from the first transistor M1 to the light emitting device OLED.

The sixth transistor M6 includes a source terminal coupled to the storage capacitor Cst, and drain and gate terminals coupled to the (n−1)^{th} scan line Sn−1. The sixth transistor M6 is turned on when the scan signal is transmitted to the (n−1)^{th} scan line Sn−1, thereby initializing the storage capacitor Cst and the gate terminal of the first transistor M1.

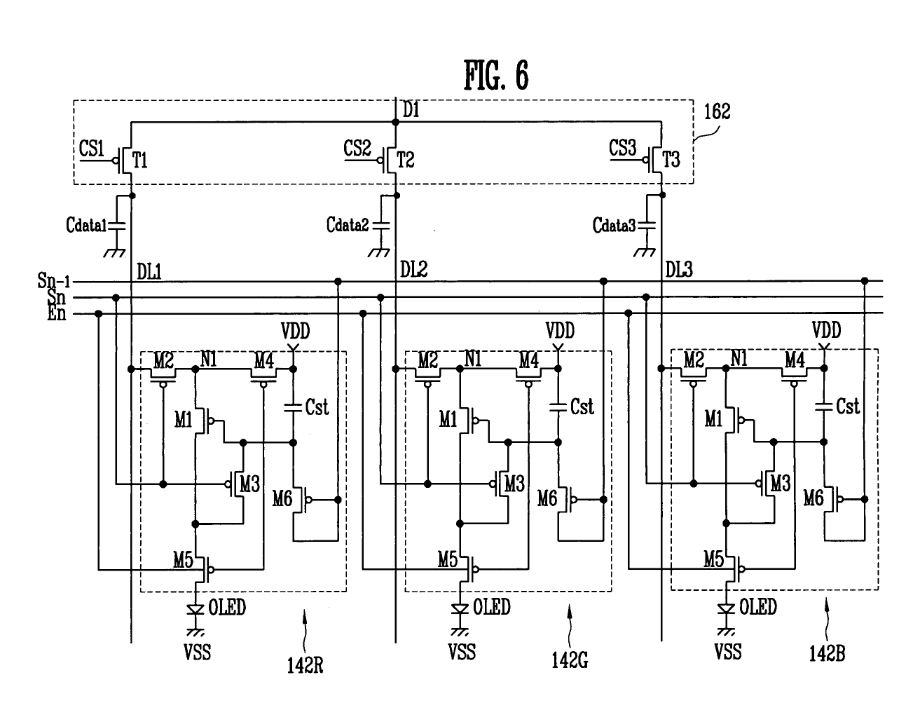

FIG. 6 is a circuit diagram showing connection between the demultiplexer 162 and the pixel 142 according to the first embodiment of the present invention. In this example, one demultiplexer 162, where i is equal to 3, is coupled with three R, G, B, pixels 142R, 142G, 142B.

Referring now to FIGS. 4A and 6 to demonstrate the operation of the demultiplexer 162 and the pixel 140, first, the scan signal is transmitted to the (n−1)^{th} scan line Sn−1 during the scan period in the one horizontal period. When the scan signal is transmitted to the (n−1)^{th} scan line Sn−1, the sixth transistor M6 of each of the pixels 142R, 142G, 142B is turned on. As the sixth transistor M6 is turned on, the storage capacitor Cst and the gate terminal of the first transistor M1 are coupled to the (n−1)^{th} scan line Sn−1. That is, when the scan signal is transmitted to the (n−1)^{th} scan line Sn−1, the scan signal is supplied to the storage capacitor Cst and the gate terminal of the first transistor M1 provided in each of the pixels 142R, 142G, 142B, thereby initializing the storage capacitor Cst and the gate terminal of the first transistor M1 of each pixel. The scan signal applied to the n^{th} scan line Sn in this case has a voltage level lower than that of the data signal.

While the scan signal is transmitted to the (n−1)^{th} scan line Sn−1, the second transistor M2 coupled to the n^{th} scan line Sn is kept turned off. Next, the first, second, and third switching devices T1, T2, T3 are turned on in sequence by the first, second, and third control signals CS1, CS2, CS3 transmitted in sequence during the data period. When the first switching device T1 is turned on by the first control signal CS1, the data signal is transmitted from the 1^{st} first data line D1 to the 1^{st} second data line DL1. As a result, the first data capacitor Cdata1 is charged with voltage corresponding to the data signal transmitted to the 1^{st} second data line DL1.

When the second switching device T2 is turned on by the second control signal CS2, the data signal is transmitted from the 1^{st} first data line D1 to the 2^{nd} second data line DL2. At this time, the second data capacitor Cdata2 is charged with voltage corresponding to the data signal transmitted to the 2^{nd} second data line DL2. When the third switching device T3 is turned on by the third control signal CS3, the data signal is transmitted from the 1^{st} first data line D1 to the 3^{rd} second data line DL3. At this time, the third data capacitor Cdata3 is charged with voltage corresponding to the data signal transmitted to the 3^{rd} second data line DL3. Because, the scan signal, applied to the n^{th} scan line Sn, is not supplied during the data period and the first transistor M1 stays off in each pixel 142R, 142G, 142 B, the data signal is not supplied to the pixels 142R, 142G, 142B.

As shown on FIG. 4A, following the data period, the scan signal is transmitted to the n^{th} scan line Sn. When the scan signal is transmitted to the n^{th} scan line Sn, the second transistor M2 and the third transistor M3 of each of the pixels 142R, 142G, 142B are turned on. As the second transistors M2 and the third transistors M3 of the pixels 142R, 142G, 142B are turned on, voltages corresponding to the data signals stored in the first, second, and third data capacitor Cdata1, Cdata2, Cdata3 are supplied to the first nodes N1 of the respective pixels 142R, 142G, 142B.

Because the voltage applied to the gate terminal of the first transistor M1 provided in each of the pixels 142R, 142G, 142B is initialized by the scan signal transmitted to the (n−1)^{th} scan line Sn−1, and is set to have a voltage level lower than that of the data signal applied to the first node N1, the first transistor M1 is turned on. As the first transistor M1 is turned on, the voltage corresponding to the data signal applied to the first node N1 is supplied to one terminal of the storage capacitor Cst via the first transistor M1 and the third transistor M3. As a result, the storage capacitor Cst provided in each of the pixels 142R, 142G, 142B is charged with a sum of two voltages including a voltage corresponding to the data signal as well as a voltage corresponding to the threshold voltage of the first transistor M1. While the emission control signal EMI (shown in FIG. 4B) is not supplied through the emission control line En, the fourth and fifth transistors M4, M5 are turned on, so that current corresponding to the voltage charged in the storage capacitor Cst is supplied to the light emitting device OLED, thereby allowing the light emitting device OLED to emit light.

Thus, according to an embodiment of the present invention, the demultiplexer 162 is employed for splitting and supplying the data signal from the first data line D1 to a number of (i.e., i) second data lines DL. Further, the data capacitor Cdata is charged with the voltage corresponding to the data signal during the data period, and supplies the charged voltage to the pixel during the scan period. According to the embodiments shown in FIGS. 4A and 4B, the scan period for supplying the scan signal and the data period for supplying the data signal do not overlap, so that the voltage applied to the gate terminal of the third transistor M3 does not fluctuate, thereby allowing the LED to display a stable image. Further, the voltages stored in the data capacitors Cdata are supplied to the pixels 140 at the same time, that is, the data signals are supplied to the pixels 140 all together, so that the LED can display an image with uniform brightness.

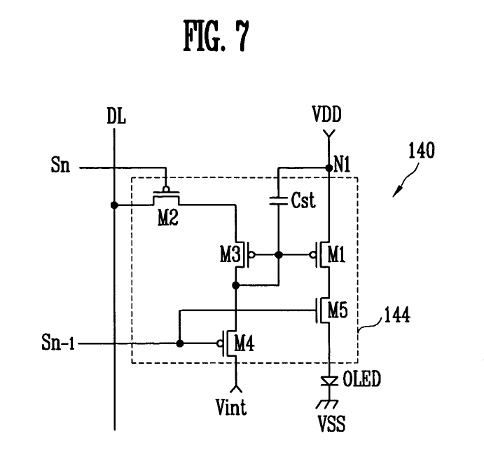

FIG. 7 is a circuit diagram of a pixel 140 provided in the LED according to a second embodiment of the present invention. The circuit for a pixel 140 is not limited to the structure shown in this figure and may include at least one transistor capable of being used as a diode. Each pixel 140 includes a light emitting device OLED, and a pixel circuit 144 coupled to the second data line DL and to the scan lines and controlling and causing the light emitting device OLED to emit light.

The light emitting device OLED includes an anode electrode coupled to the pixel circuit 144, and a cathode electrode coupled to a second voltage VSS. The second voltage VSS is lower than a first voltage VDD applied to the pixel circuit 144. For example, ground voltage can be applied as the second voltage VSS. The light emitting device OLED emits light corresponding to current supplied from the pixel circuit 144. To emit light, the light emitting device OLED may include fluorescent and/or phosphorescent organic material.

The pixel circuit 144 includes a first transistor M1 and a fifth transistor M5 coupled between the first voltage VDD and the light emitting device OLED, a second transistor M2 which is coupled to both the second data line DL and the n^{th} scan line Sn, a third transistor M3 and a fourth transistor M4 which are coupled between the second transistor M2 and an initialization voltage line Vint, and a storage capacitor Cst which ic coupled between a source terminal and a gate terminal of the first transistor M1. In FIG. 7, the first through fourth transistors M1, M2, M3, M4 are of a PMOSFET type and the fifth transistor M5 is of an NMOSFET type. However, this circuit is not limited to the types shown and transistor types may vary as long as the fifth transistor M5 is of a different type from the first through fourth transistors M1, M2, M3, M4. In the case where the first through fourth transistors M1, M2, M3, M4 are of the NMOSFET type, polarity of driving waveforms is reversed as well-known to those skilled in the art.

The first transistor M1 includes the source terminal that is coupled to the first node N1, the drain terminal that is coupled to a source terminal of the fifth transistor M5, and a gate terminal that is coupled to a gate terminal of the third transistor M3. As such, the first transistor M1 supplies current corresponding to voltage charged in the storage capacitor Cst to the light emitting device OLED.

The fifth transistor M5 includes a drain terminal coupled to the light emitting device OLED and a gate terminal coupled to the (n−1)^{th} scan line Sn−1. The fifth transistor M5 is turned on when the scan signal is not supplied to the (n−1)^{th} scan line Sn−1 which corresponds to a higher voltage on the scan lines according to FIGS. 4 and 5. While the fifth transistor M5 is on it supplies current from the first transistor M1 to the light emitting device OLED.

The second transistor M2 includes a gate terminal coupled to the n^{th} scan line Sn, a source terminal coupled to the second data line DL, and a drain terminal coupled to a source terminal of the third transistor M3. The second transistor M2 is turned on when the scan signal is transmitted to the n^{th} scan line Sn, thereby transmitting the data signal from the data line DL to the third transistor M3.

The third transistor M3 includes a drain terminal coupled to a source terminal of the fourth transistor M4. The drain terminal of the third transistor M3 is electrically coupled to its gate terminal. Because the drain terminal and the gate terminal of the third transistor M3 are electrically coupled to each other, the third transistor M3 functions as a diode.

The fourth transistor M4 includes a gate terminal coupled to the (n−1)^{th} scan line Sn−1, and a drain terminal coupled to the initialization voltage line Vint. The fourth transistor M4 is turned on when the scan signal is transmitted to the (n−1)^{th} scan line Sn−1, thereby supplying the initialization voltage Vint to the third transistor M3.

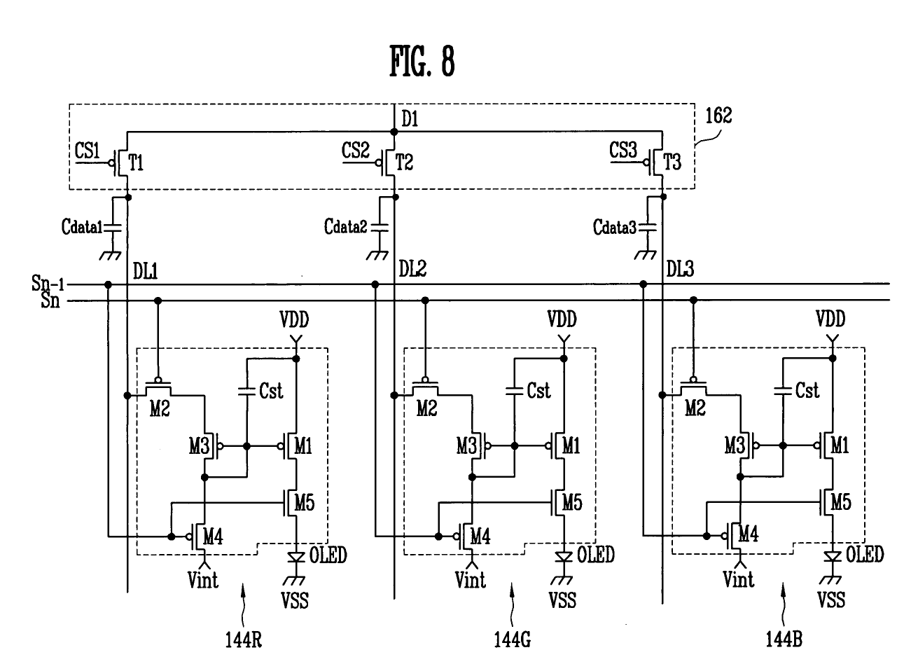

FIG. 8 is a circuit diagram showing a connection between the demultiplexer 162 and the pixels 140 that include pixel circuits 144 of the second embodiment of the present invention. For convenience, one demultiplexer 162 is shown that is coupled with three R, G, B pixels 144R, 144G, 144B and therefore i is 3.

Referring now to FIGS. 4A and 8 to demonstrate the operations of the demultiplexer 162 and the pixel 140, first, the scan signal is transmitted to the (n−1)^{th} scan line Sn−1 during the scan period in the one horizontal period 1H. When the scan signal is transmitted to the (n−1)^{th} scan line Sn−1, the fourth transistor M4 of each of the pixels 144R, 144G, 144B is turned on. As the fourth transistor M4 is turned on, one terminal of the storage capacitor Cst, the gate terminal of the first transistor M1, and the gate terminal of the third transistor M3 are all coupled to the initialization voltage Vint. That is, when the fourth transistor M4 is turned on, the initialization power Vint is supplied to and initializes the terminal of the storage capacitor Cst, the gate terminal of the first transistor M1, and the gate terminal of the third transistor M3. The initialization voltage Vint is set to have a voltage lower than that obtained by subtracting the threshold voltage of the third transistor M3 from the lowest voltage of the data signal that can be supplied from the data driver 120.

When the scan signal is transmitted to the (n−1)^{th} scan line Sn−1, the second transistor M2 coupled to the n^{th} scan line Sn remains turned off. Then, the first through third switching devices T1, T2, T3 are turned on in sequence by the first through third control signals CS1, CS2, CS3 transmitted in sequence during the data period following the scan period shown on FIG. 4A. When the first switching device T1 is turned on by the first control signal CS1, the data signal is transmitted from the 1^{st} first data line D1 to the 1^{st} second data line DL1. As long as the second transistor M2 is off, the first data capacitor Cdata1 is charged with voltage corresponding to the data signal transmitted to the 1^{st} second data line DL1.

When the second switching device T2 is turned on by the second control signal CS2, the data signal is transmitted from the 1^{st} first data line D1 to the 2^{nd} second data line DL2. Again, while the second transistor M2 is off, the second data capacitor Cdata2 is charged with voltage corresponding to the data signal transmitted to the 2^{nd} second data line DL2. When the third switching device T3 is turned on by the third control signal CS3, the data signal is transmitted from the 1^{st} first data line D1 to the 3^{rd} second data line DL3. As a result, the third data capacitor Cdata3 is charged with voltage corresponding to the data signal transmitted to the 3^{rd} second data line DL3. As seen in FIG. 4A, the scan signal is not supplied during the data period keeping the second transistors M2 off and the data signal is not supplied to the pixels 144R, 144G, 144B.

Following the data period, the scan signal is transmitted to the n^{th} scan line Sn. When the scan signal is transmitted to the n^{th} scan line Sn, each second transistor M2 of the pixels 144R, 144G, 144B is turned on. According as each second transistor M2 of the pixels 144R, 144G, 144B is turned on, voltages corresponding to the data signals stored in the first through third data capacitor Cdata1 through Cdata3 are supplied to the source terminal of the third transistor M3 provided in the pixels 144R, 144G, 144B. At this time, because the gate terminal of the third transistor M3 is initialized by the initialization power Vint, that is, has a voltage level lower than that of the source terminal, the third transistor M3 is turned on. When the third transistor M3 is turned on, the data signal is supplied to the gate terminal of the third transistor M3, that is, to the one terminal of the storage capacitor Cst. At this time, each storage capacitor Cst provided in the pixels 144R, 144G, 144B is charged with voltage corresponding to the data signal. Further, the storage capacitor Cst is charged with voltage corresponding to the threshold voltage of the first transistor M1 in addition to the voltage corresponding to the data signal.

Thus, according to an embodiment of the present invention, the demultiplexer 162 is employed for splitting and supplying the data signal from the first data line D1 to i second data lines DL. Further, the data capacitor Cdata is charged with the voltage corresponding to the data signal during the data period, and supplies the charged voltage to the pixel during the succeeding scan period. According to an embodiment of the present invention, the scan period for supplying the scan signal and the data period for supplying the data signal do not overlap, so that the voltage applied to the gate terminal of the third transistor M3 does not fluctuate, thereby allowing the LED to stably display an image. Further, the voltages stored in the data capacitors Cdata are supplied to the pixels simultaneously, that is, the data signals are supplied to the all the relevant pixels at the same time, so that the LED can display an image with uniform brightness.

Although exemplary embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A light emitting display comprising:
a scan driver supplying scan signals to scan lines during a first period in a one horizontal period;
a data driver having a plurality of output lines and supplying a plurality of data signals to the output lines during a second period in the one horizontal period, the second period not overlapping with the first period;
a plurality of demultiplexers, each demultiplexer coupled to one of the output lines, each demultiplexer supplying the data signals from one of the output lines to a group of the plurality of data lines;
an image displaying part including a plurality of pixels formed in regions defined by the scan lines and the plurality of data lines; and
a plurality of capacitors, each capacitor coupled to one of the data lines, each capacitor chargeable with a voltage corresponding to the data signals supplied to the data lines,
wherein each pixel includes a light emitting device capable of producing emitted light upon receiving one of the data signals.

2. The light emitting display of claim 1, wherein each pixel comprises a plurality of transistors, at least one of the transistors having connected terminals and functioning as a diode, the transistor functioning as a diode being a diode transistor.

3. The light emitting display of claim 2, wherein an initialization voltage is supplied to the diode transistor to forward bias the diode transistor when the data signal is being transmitted to the pixel.

4. The light emitting display of claim 1, wherein the demultiplexer comprises a plurality of transistors coupled to the data lines.

5. The light emitting display of claim 4, further comprising a demultiplexer controller for supplying a control signal to the plurality of transistors to be turned on in sequence during the second period.

6. The light emitting display of claim 5,
wherein each capacitor is charged with the voltage corresponding to the data signals after the plurality of transistors are turned on in sequence during the second period, and
wherein the voltage is supplied from each capacitor to the pixels during a first period succeeding the second period.

7. The light emitting display of claim 6, wherein the data driver supplies a dummy data signal to the output lines during the first period, the dummy signal having no effect on a brightness of the emitted light.

8. The light emitting display of claim 7, wherein the dummy data signal supplied during the first period in a k^{th} horizontal period is set as the last data signal supplied during the second period in a (k−1)^{th} horizontal period, where k is a natural number equal to or greater than 2.

9. The light emitting display of claim 1, wherein each capacitor includes a parasitic capacitor equivalently formed on the respective data line coupled to each capacitor.

10. The light emitting display of claim 1, wherein each capacitor includes an external capacitor additionally formed on each data line coupled to each capacitor.

11. The light emitting display of claim 2, wherein each pixel further includes:
a first transistor controlling a current to be supplied to the light emitting device corresponding to the data signal;
a storage capacitor coupled to the first transistor for storing a voltage corresponding to the data signal; and
a second transistor controlled by an n^{th} scan line and coupled to one of the data lines, the second transistor capable of transmitting the data signal from the data line to the storage capacitor.

12. The light emitting display of claim 11, wherein a capacitance of each of the capacitors is larger than a capacitance of the storage capacitor.

13. The light emitting display of claim 11, wherein each pixel further includes:
a third transistor coupled between the second transistor and the first transistor and having a gate terminal and a drain terminal coupled to each other;
a fourth transistor controlled by an (n−1)^{th} scan line and coupled to the third transistor and to an initialization power line; and
a fifth transistor controlled by the (n−1)^{th} scan line and coupled to the light emitting device and to the first transistor.

14. The light emitting display of claim 1 1, wherein each pixel further includes:
a third transistor controlled by the n^{th} scan line, and coupled to a gate terminal and to a drain terminal of the first transistor;
a fourth transistor controlled by an emission control line;
a fifth transistor controlled by an emission control line; and
a sixth transistor having gate and drain terminals coupled to an (n−1)^{th} scan line, and a source terminal coupled to the gate terminal of the first transistor.

15. A method of driving a light emitting display, comprising:
supplying a scan signal to a scan line during a first period in a one horizontal period;
supplying a plurality of data signals to output lines of a data driver during a second period in the one horizontal period, the second period not overlapping with the first period;
turning on a plurality of transistors coupled to the output lines in sequence during the second period for supplying the data signals from the data driver to a plurality of data lines;
charging a plurality of capacitors with a voltage corresponding to the data signals during the second period, each capacitor coupled to a data line and being charged with a voltage corresponding to a data signal supplied to the data line; and
applying the voltage charged in each capacitor to a pixel coupled to the scan line and the data line during a first period of a subsequent one horizontal period, the pixel including a light emitting device coupled to each capacitor to emit light, the emitted light corresponding to the data signal supplied to the data line coupled to each capacitor.

16. The method of claim 15, further comprising supplying a dummy data signal to each output line provided in the data driver during the first period, the dummy data signal having no effect on a brightness of the emitted light.

17. The method of claim 16, wherein the dummy data signal supplied during the first period in a k^{th} horizontal period is set as the last data signal supplied during the second period in a (k−1)^{th} horizontal period, where k is a natural number equal to or greater than 2.

18. The method of claim 15, wherein each capacitor includes a parasitic capacitor, the parasitic capacitor equivalently formed on the respective data line.

19. The method of claim 15, wherein each capacitor includes an external capacitor additionally formed on each data line.

20. The method of claim 18, wherein a capacitance of each capacitor is larger than a capacitance of a storage capacitor provided in each pixel.

21. The method of claim 19, wherein the capacitance of each capacitor is larger than a capacitance of a storage capacitor provided in each pixel.

22. A method of driving a light emitting display having capacitors coupled to pixels via data lines, the capacitors receiving data signals via the data lines and supplying the data signals to the pixel via the data lines, the method comprising:
charging the capacitors coupled to the data lines in sequence with voltages corresponding to the data signals; and
simultaneously supplying the voltages charged in the capacitors to the pixels.

23. The method of claim 22, wherein the capacitor is charged with the voltage corresponding to the data signal during a first period in a one horizontal period.

24. The method of claim 23, wherein each pixel receives the voltage charged in the capacitor during a second period in the one horizontal period, the second period not overlapping with the first period.
